(19) United States
(12) Patent Application Publication
(10) Pub. No.: US 2015/0036780 A1
(43) Pub. Date: Feb. 5, 2015

(54) Liquid Nitrogen Nuclear Generator

(71) Applicant: Scott Clair Pockrandt, Ridgecrest, CA (US)

(72) Inventor: Scott Clair Pockrandt, Ridgecrest, CA (US)

(21) Appl. No.: 13/987,479

(22) Filed: Jul. 30, 2013

(51) Int. Cl. G21D 7/00

(52) U.S. Cl. CPC G21D 7/00
USPC 376/322

(57) ABSTRACT

The Liquid Nitrogen Nuclear Generator uses electrical energy and liquid Nitrogen from an existing nuclear power plant, equipped with a Liquid Nitrogen cooling system, to generate power in any form required, providing continuous, augmented, supplemental or alternate output in any predetermined form, including but not limited to electrical, mechanical and/or hydraulic, which may be produced individually or in any combination.

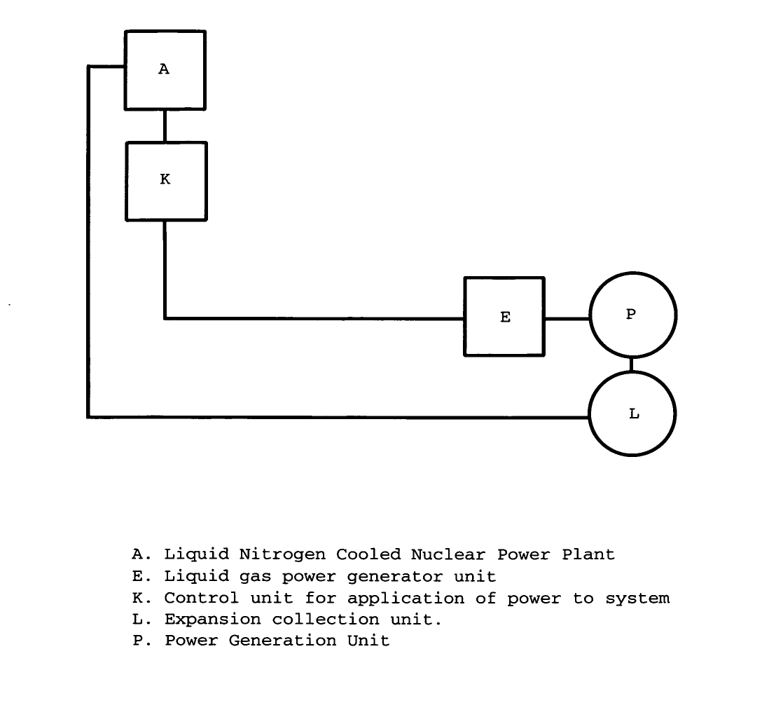

Nitrogen is extracted from the atmosphere, condensed, cooled, stored in liquid form, then expanded to be applied to the generation unit which is selected to provide the type of power needed, allowing reduction of size of the nuclear plant supplying power to this system while maintaining its output, at a steady and reduced rate of generation, and recycling the expanded Nitrogen gas within the closed system to provide increased efficiency.

### FERDERALLY SPONSORED RESERACH

Not applicable.

### SEQUENCE LISTING OR PROGRAM

Not applicable.

Submission of Drawing and description.

The following paragraphs describe the operation of the Liquid Nitrogen Nuclear Generator (hereinafter referred to as “System”), and explains the drawing.

Drawing 1:

Power, in the form of electricity, and liquid Nitrogen are applied from an existing Liquid Nitrogen Cooled Nuclear power generation plant (A), to the System through the Control Unit (K) which regulates the action of, application of power to, and generation of power by, the System. Note that the use of the term “gas” in this paper refers to Nitrogen gas in any physical form, including liquid, gaseous, and others.

When required and for any duration, including continuous operation, liquid Nitrogen is applied to the Liquid Gas Power Generator Unit (E) which provides the necessary actions to expand the Nitrogen from any physical form, to provide drive to the Power Generation Unit (P), which in turn produces the required amount and form of power to be used, including, but not limited to, mechanical, hydraulic, electrical, or any other form.

The gas which passes through the Power Generation Unit (P), is collected in the Expansion Collection Unit (L), and recycled through a closed system to the Liquid Nitrogen Cooled Nuclear power generation plant(A).

1. I have developed a process and method for storing and utilizing the output of an existing nuclear power generation plant to provide continuous, augmented, alternate and/or supplemental output of power of any predetermined type, including but not limited to electrical, mechanical and hydraulic, which can be produced individually or in any combination, without additional consumption of additional fuel, or production of greenhouse gases.
